(19) United States
(12) Patent Application Publication
(10) Pub. No.: US 2010/0125843 A1
(43) Pub. Date: May 20, 2010

(54) VIRTUAL SERVER SYSTEM, PHYSICAL CPU AND METHOD FOR ALLOCATING PHYSICAL MEMORY

(75) Inventors: Jun SAITO, Hadano (JP); Hidetoshi SATO, Ebina (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/617,747

(22) Filed: Nov. 13, 2009

(30) Foreign Application Priority Data
Nov. 18, 2008 (JP) 2008-294562

(51) Int. Cl. G06F 9/455

(52) U.S. Cl. 718/1

(57) ABSTRACT

The present invention prevents performance degradation due to memory latency in automatically allocating physical CPUs and memories to logical servers. Having information on arrangement of the physical CPUs and the memories, automatic allocation of physical CPUs to a logical server is implemented in consideration of reduction in memory latency. Moreover, the logical servers and the physicals CPU are grouped. Thereby, to each of the logical servers, a physical CPU in the same group as that of the logical server is allocated, and a memory under the memory controller to which the physical CPU belongs is allocated. In this way, the physical CPUs are allocated in consideration of reduction in memory latency.

### BACKGROUND OF THE INVENTION

1. Field of the Invention

The present invention relates to a virtual server system and a method for automatically allocating computer resources to a plurality of logical computers operated on one physical computer.

2. Description of the Related Art

A virtual computer system is one in which: a hypervisor divides a physical computer into a plurality of logical partitions (LPARs), allocates computer resources (CPU, main memory and I/O) to each LPAR, and operates an OS on each LPAR. The OS operated on each LPAR is called a guest OS in order to express that the OS is operated in a particular manner as a control program that runs on a control program such as the hypervisor.

Since the guest OS is logically operated in exactly the same manner as a general OS, the main memory with consecutive addresses starting from Address 0 also needs to be allocated to the guest OS in the same manner as a normal memory. Thus, guest physical addresses and host physical addresses are distinctively used as the addresses of the main memory, and the guest OS is normally operated by converting the guest physical address into the host physical address on the LPAR.

[Patent Document 1] Japanese Patent Application Publication No. 2008-77652

### SUMMARY OF THE INVENTION

The conventional art performs control of sequentially allocating a physical CPU and a memory block, which are not used by other logical servers, to a logical server to be activated, but does not perform control of allocating the physical CPU and the memory block in consideration of memory latency. Therefore, LPAR performance degradation due to the influence of memory latency has become a problem. The only way to avoid such a problem is for a user to determine which physical CPU to be allocated to the LPAR, by taking physical arrangement of the physical CPU and the memory block into account. However, this method is applicable only to the case where the LPAR exclusively uses the physical CPU. Meanwhile, when the LPARs time-share the physical CPU with each other, there is no method to avoid the influence of memory latency.

In the present invention, a hypervisor has information on physical arrangement of a CPU and a memory block and allocates the CPU and the memory block to LPARs in consideration of reduction in memory latency. Moreover, when the LPARs time-share a physical CPU with each other, the LPARs and the physical CPU are grouped, and the physical CPU in the same group as that of the LPARs is allocated to the LPARs, thereby performing allocation of the physical CPU in consideration of reduction in memory latency.

Specifically, a virtual server system of the present invention includes a plurality of CPU modules each including a plurality of physical CPUs and a memory controller; a plurality of physical memories connected to the memory controller of each CPU module; a hypervisor allocating the physical CPUs and physical memory blocks to a plurality of logical servers; a logical server configuration management table in which each of the logical servers, a logical CPU mode thereof, a required number of logical CPUs and a required logical memory size are registered in association with each other, a CPU management table in which information on each of the physical CPUs, a CPU mode thereof, a logical server using the physical CPU, and the memory controller connected to the physical CPU is stored in association with each other, and a memory management table in which information on a logical server using each of the physical memories and a memory controller connected to the physical memory is stored in association with each other on a unit capacity basis. In the virtual server system, when one of the logical servers is activated, the hypervisor acquires information on the logical CPU mode, the number of logical CPUs and the logical memory size by referring to the logical server configuration management table, allocates to the logical server a required number of physical CPUs from one of the CPU modules by referring to the CPU management table and the memory management table, and then allocates to the logical server a memory block of a required size from the physical memories connected to the memory controller of the allocated physical CPUs.

When the logical server configuration management table includes grouping information on the logical servers, the hypervisor allocates the same physical CPU to a plurality of logical servers belonging to the same group. When one of the plurality of grouped logical servers is deactivated and then activated again, the hypervisor allocates the same physical CPU as the previous one to the logical server.

The present invention also provides an allocation method for allocating a physical CPU and a physical memory block to each logical server by a hypervisor in a server system including: a plurality of CPU modules each including a plurality of physical CPUs and a memory controller; a plurality of physical memories connected to the memory controller of each CPU module; and a logical server configuration management table in which each of the logical servers, a logical CPU mode thereof, a required number of logical CPUs and a required logical memory size are registered in association with each other. In the allocation method, the hypervisor executes the steps of: initializing a CPU management table and a memory management table, the CPU management table including information on each of the physical CPUs, a CPU mode thereof, a logical server using the physical CPU, and the memory controller connected to the physical CPU associated with each other, and the memory management table including information on a logical server using each of the physical memories and a memory controller connected to the physical memory associated with each other on a unit capacity basis, acquiring information on the logical CPU and the logical memory size required for an activated one of the logical servers, from the logical server configuration management table; finding a way for allocating to the logical server a required number of CPUs from the physical CPUs mounted on one of the CPU modules by referring to the CPU management table and the memory management table, and then allocating to the logical server a memory block of a required size from the physical memories connected to the memory controller of the allocated physical CPUs; and updating the CPU management table and the memory management table when the way is successfully found.

According to the present invention, a physical CPU and a memory block are automatically allocated to LPARs in consideration of memory latency.

Moreover, by grouping the LPAR and the physical CPU, it is clarified which physical CPU is used by a logical CPU of the LPAR. Thus, there is an advantage useful in maintenance of a physical server, such as replacement of a physical CPU module during running.

### BRIEF DESCRIPTION OF THE DRAWINGS

FIG. 1 is an explanatory view of a basic configuration example of a server module according to the present invention.

FIG. 2 is a view of an LPAR configuration management table of LPARs shown in FIG. 1.

FIG. 3 is a view (before LPAR activation) of a CPU management table of CPUs shown in FIG. 1.

FIG. 4 is a view (before LPAR activation) of a memory management table of physical memories shown in FIG. 1.

FIG. 5 is a view showing steps of executing CPU allocation when a logical CPU mode of the LPAR is a dedicated mode.

FIG. 6 is a view showing steps of executing CPU allocation when the logical CPU mode of the LPAR is a time-shared mode.

FIG. 7 is a view (after LPAR activation) of a CPU management table of the CPUs shown in FIG. 1.

FIG. 8 is a view (after LPAR activation) of a memory management table of the physical memories shown in FIG. 1.

### DESCRIPTION OF THE PREFERRED EMBODIMENTS

Description will be given below with regard to embodiments of the present invention with reference to the accompanying drawings.

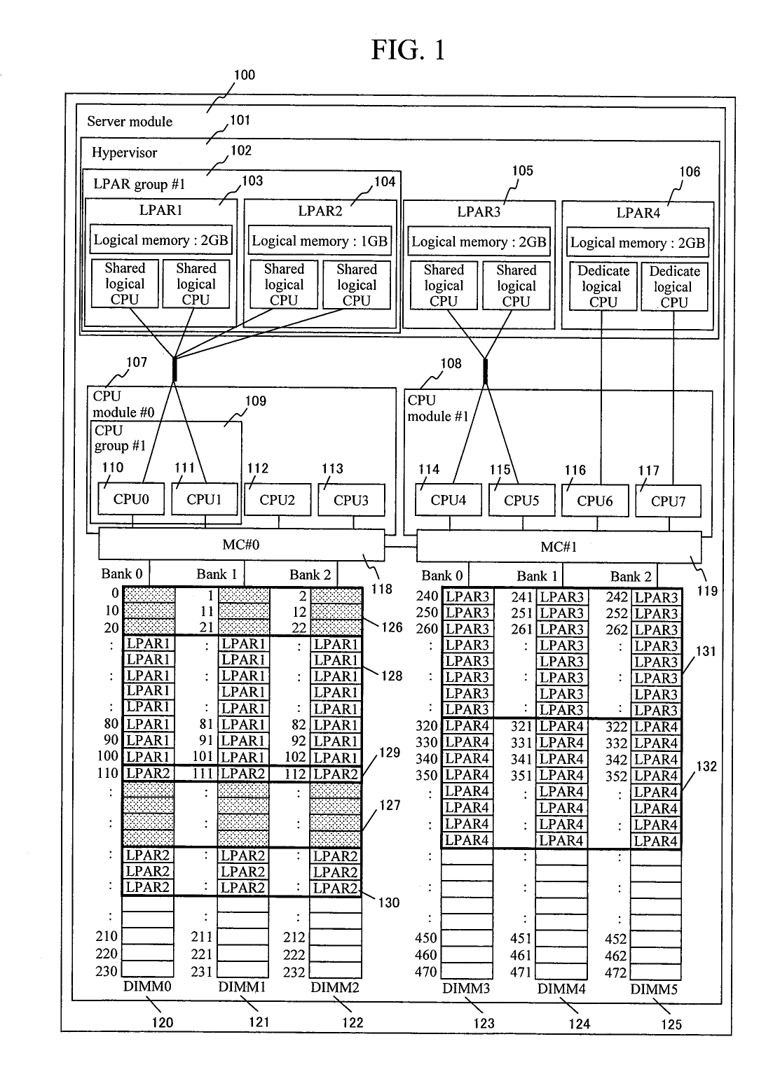

FIG. 1 is an explanatory view of a basic configuration example of a server module according to the present invention. A server module 100 includes two CPU modules (107 and 108), each having four physical CPUs 110 to 113 or 114 to 117. The CPU modules include memory controllers 118 and 119, respectively, and each of the memory controllers has a three-way interleave configuration including three DIMMs (2 GB) 120 to 122 or 123 to 125. A wiring distance between the physical CPUs 110 to 113 and the DIMMs 120 to 122 or between the physical CPUs 114 to 117 and the DIMMs 123 to 125, which are connected to the same memory controller, is 45 mm. A wiring distance between the physical CPUs 110 to 113 and the DIMMs 123 to 125 or between the physical CPUs 114 to 117 and the DIMMs 120 to 122, which are connected to the different memory controllers, is 450 mm.

A hypervisor 101 is a virtualization mechanism for making one physical server logically look like a plurality of servers. The hypervisor operates by using memory blocks 126 and 127 in an occupied manner. There are four logical computers (LPARs) 103 to 106 on the hypervisor, and activation of the LPARs is performed in the order of LPAR1 (103), LPAR2 (104), LPAR3 (105) and LPAR4 (106). The LPAR1 (103) requires a logical memory 2 GB and two shared logical CPUs which time-share the physical CPUs, and belongs to an LPAR group #1 (102). The LPAR2 (104) requires a logical memory 1 GB and two shared logical CPUs which time-share the physical CPUs, and belongs to the LPAR group #1 (102). The LPAR3 (105) requires a logical memory 2 GB and two shared logical CPUs which time-share the physical CPUs, and does not belong to any LPAR group. The LPAR4 (106) requires a logical memory 2 GB and two dedicated logical CPUs which occupy the physical CPUs.

When the LPAR1 (103) is activated, the hypervisor recognizes the LPAR1 (103) as the LPAR belonging to the LPAR group #1 (102), and allocates the two physical CPUs 110 and 111 of a CPU group #1 and a memory block 128 of 2 GB to the LPAR. When the LPAR2 (104) is activated, as in the case of the LPAR1 (103), the hypervisor recognizes the LPAR2 (104) as the LPAR belonging to the LPAR group #1 (102), and allocates the two physical CPUs 110 and 111 of the CPU group #1 and memory blocks 129 and 130 of 1 GB to the LPAR. When the LPAR3 (105) is activated, the hypervisor checks unused physical CPUs and unused memory blocks since the LPAR3 is the one that does not belong to any LPAR group. As a result, the two physical CPUs 114 and 115 and a memory block 131 of 2 GB are allocated to the LPAR3 (105). When the LPAR4 (106) is activated, the hypervisor recognizes the LPAR4 (106) as the LPAR having the logical CPUs which use the physical CPUs in an occupied manner, and checks unused physical CPUs and unused memory blocks. As a result, the two physical CPUs 116 and 117 and a memory block 132 of 2 GB are allocated to the LPAR4 (106).

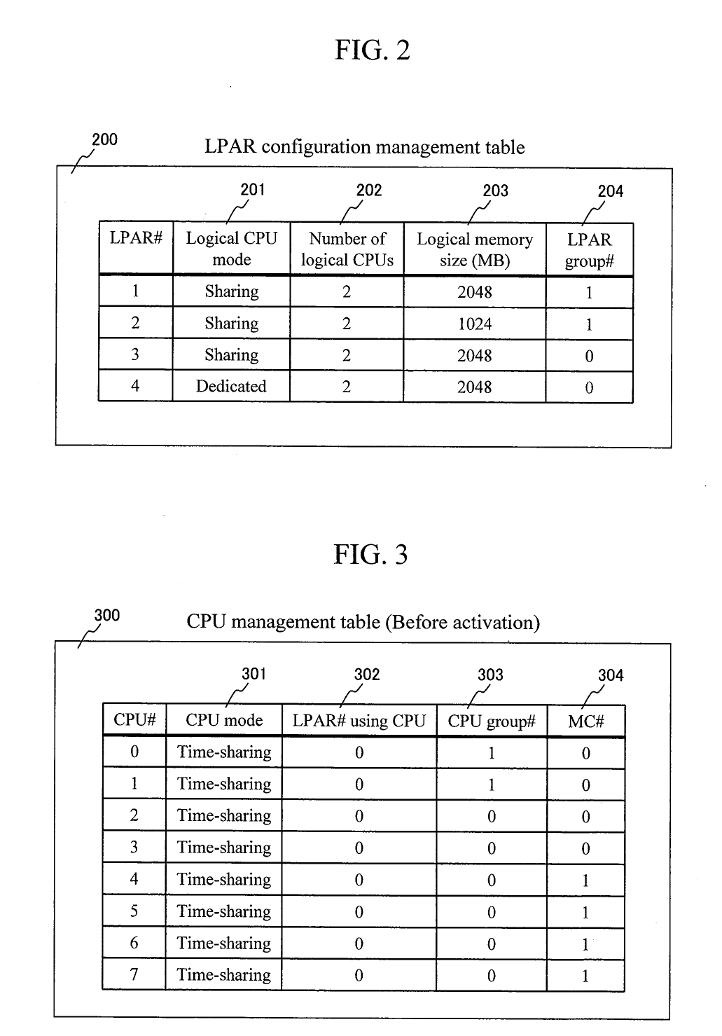

FIG. 2 shows an LPAR configuration management table 200 of the four LPARs 103 to 106 shown in FIG. 1. This LPAR configuration management table includes a logical CPU mode 201 of each LPAR, the number of logical CPUs (202), a logical memory size (203) and an LPAR group # (204). Information included in the LPAR configuration management table is inputted by a user. Upon activation of the LPARs, the hypervisor 101 uses the information in the LPAR configuration management table about each of the LPARs and allocates required CPU and memory block to the LPAR.

FIG. 3 shows a CPU management table 300 of the physical CPUs 110 to 117 shown in FIG. 1. This CPU management table is managed for each CPU by the hypervisor 101. The CPU management table includes, for each physical CPU, a CPU mode 301, an LPAR # using the CPU (302), a CPU group # (303) and an MC # (304). By the hypervisor 101, the CPU mode 301 is initialized to a time-sharing mode, the LPAR # using the CPU (302) is initialized to 0, and the CPU group # (303) is initialized to 0.

The MC # (304) is initialized by the hypervisor, and the number of the memory controller mounted on the CPU module including the physical CPUs is given thereto. Although described in detail later, the MC # (304) is used to perform allocation of the physical CPUs in consideration of reduction in memory latency. Moreover, the MC # (304) is not updated after initialized by the hypervisor. Information on the CPU group # (303) is inputted by the user. When the LPAR is activated, the CPU mode 301 and the LPAR # using the CPU (302) are updated. Moreover, when the LPAR is deactivated, those described above return to initial states.

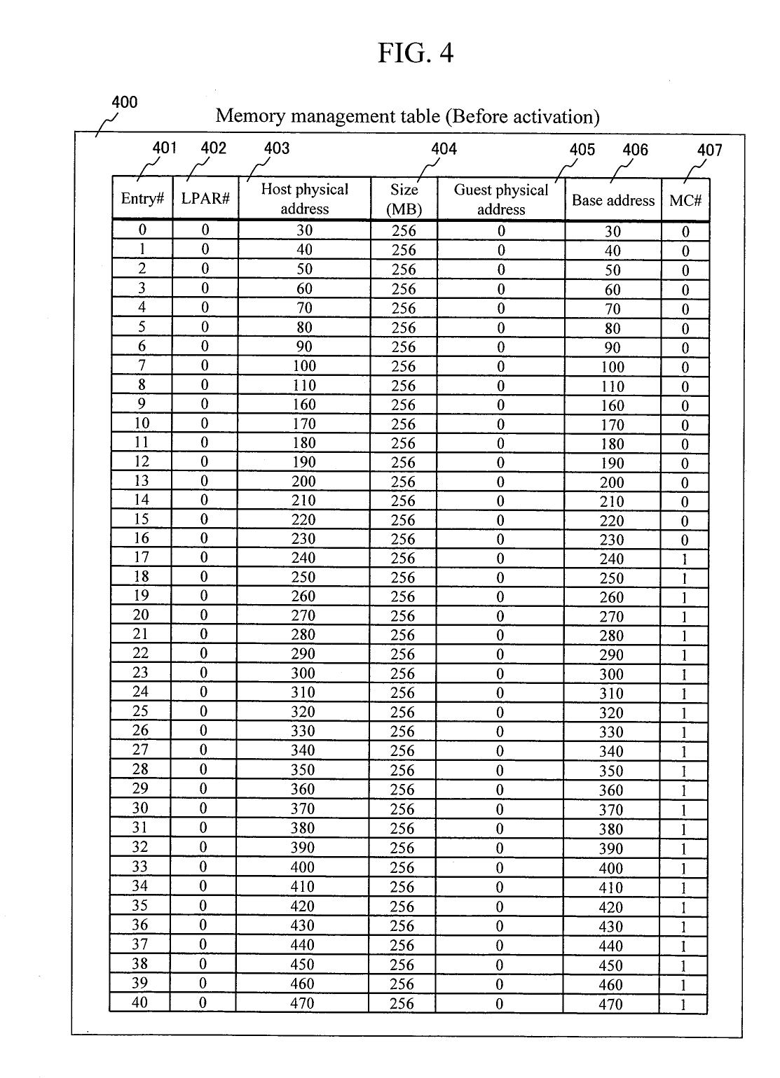

FIG. 4 shows a memory management table 400 owned by the hypervisor to manage allocation of the physical memories 120 to 125 shown in FIG. 1 to the LPARs. The memory management table is managed while dividing the physical memories 120 to 125 into entries 401, each having 256 MB, by the hypervisor 101 in order to allocate the physical memories 120 to 125 by unit of 256 MB to the LPARs. The memory management table includes, for each entry of 256 MB, an LPAR # (402), a host physical address 403, a size 404, a guest physical address 405, a base address 406 and an MC # (407). By the hypervisor 101, the LPAR # (402) and the guest physical address 405 are initialized to “0” and the host physical address 403 and the base address 406 are initialized to addresses of the physical memories 120 to 125.

The MC # (407) is initialized by the hypervisor, and the number of the memory controller to which each physical memory is connected is given thereto. Although described in detail later, the MC # (407) is used to perform allocation of the physical memories in consideration of reduction in memory latency.

When the LPAR is activated, the LPAR # (402), the guest physical address 405 and the base address 406 are updated. Moreover, when the LPAR is deactivated, those described above return to initial states.

The LPAR configuration management table 200, the CPU management table 300 and the memory management table 400 are held in the memory blocks 126 and 127 occupied by the hypervisor and accordingly referred to by the hypervisor.

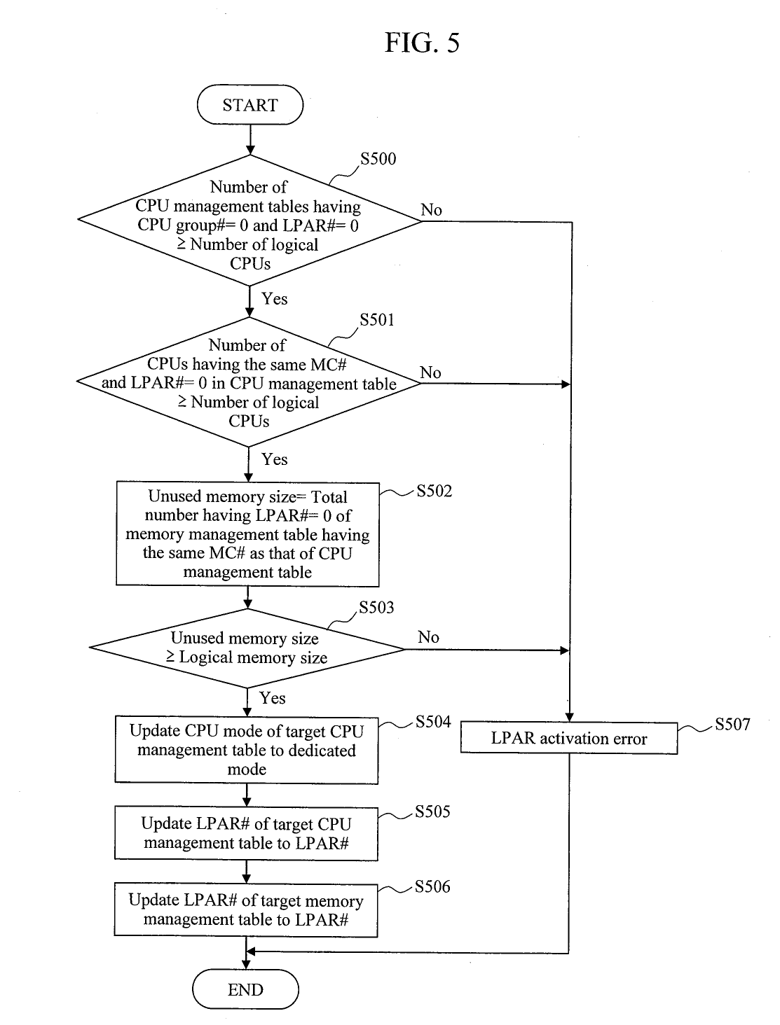

FIG. 5 is a flowchart of determining physical CPUs and physical memories to be allocated to the LPARs by the hypervisor when the logical CPU mode of the LPAR to be activated is a dedicated mode. In this determination, the CPU management table 300 and the memory management table 400 are used to reduce the memory latency.

When the LPAR is activated, the number of CPUs having the LPAR # using the CPU (302) of 0 and the CPU group # (303) of 0 in the CPU management table 300 is compared with the number of logical CPUs (202) of the activated LPAR in order to check if the number of unused physical CPUs in another LPAR is equal to or larger than the number of logical CPUs (202) of the activated LPAR (S500).

When the number of unused physical CPUs is below the number of logical CPUs (202) of the activated LPAR, it is determined that the physical CPUs cannot be allocated, resulting in an LPAR activation error (S507).

When the number of unused physical CPUs is equal to or larger than the number of logical CPUs (202) of the activated LPAR, then it is checked if the number of unused physical CPUs in the same memory controller is equal to or larger than the number of logical CPUs (202) of the activated LPAR. In order to check this, the number of CPUs having the same MC # (304) and the LPAR # using the CPU (302) of 0 in the CPU management table 300 is compared with the number of logical CPUs (202) of the activated LPAR (S501).

When the number of unused physical CPUs is equal to or larger than the number of logical CPUs (202) of the activated LPAR, it is checked if unused memory blocks are equal to or larger than the logical memory size (203) of the activated LPAR. In order to check this, a memory block size is obtained, at which the MC # (407) of the memory management table 400 is the same as the MC # (304) of the CPU management table 300 and the LPAR # (402) of the memory management table 400 is 0 (S502). When the unused memory block size is below the logical memory size, it is determined that the memory blocks cannot be allocated, resulting in the LPAR activation error (S507).

When the unused memory block size is equal to or larger than the logical memory size, the memory blocks are allocated to the LPARs and thus the CPU management table 300 and the memory management table 400 are changed to a state of being allocated to the LPAR. First, the CPU mode 301 of the CPU management table 300 corresponding to the physical CPU determined to be allocatable to the LPAR is set to the dedicated mode (S504). Next, the LPAR # using the CPU (302) of the CPU management table 300 is set to the LPAR # (S505). Finally, the LPAR # (402) of the unused memory blocks in the memory management table 400 is set to the LPAR # (S506).

Accordingly, the physical CPUs and the physical memories to be allocated to the LPARs coincide with the MC # (304) in the CPU management table 300 and the MC # (407) in the memory management table 400. Moreover, as the allocated physical CPUs and physical memories, those not in both CPU modules but in the same CPU module are used. As a result, according to this embodiment, the physical CPUs and physical memories having a short wiring distance from the memory controller are allocated. Thus, an increase in a wiring distance between the physical CPU and the physical memory, as in allocation between the CPU modules, does not occur, thereby taking into consideration the memory latency.

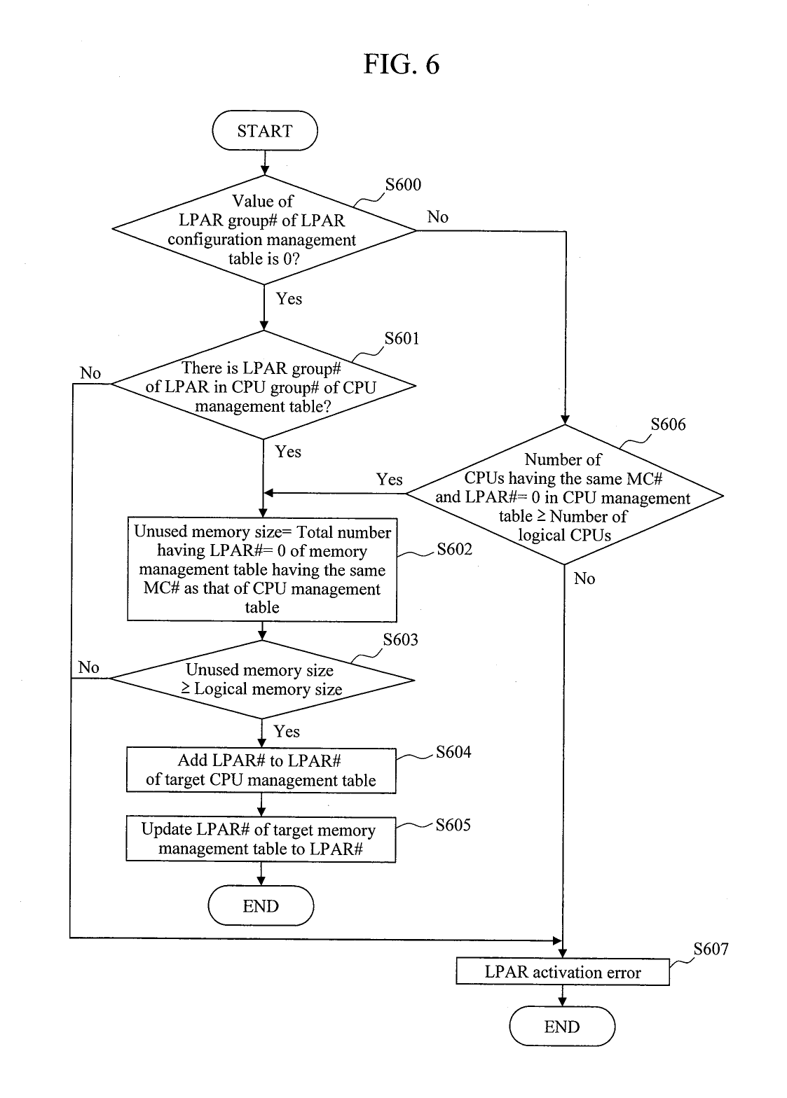

FIG. 6 is a flowchart of determining physical CPUs and physical memories to be allocated to the LPARs by the hypervisor when the logical CPU mode of the LPAR to be activated is a time-sharing mode. Also in this determination, the CPU management table 300 and the memory management table 400 are used to reduce the memory latency.

When the LPAR is activated, it is checked if a value of the LPAR group # (204) of the LPAR is 0 (S600). When the group # of the LPAR is not 0, it is checked if the same group # as the LPAR group # (204) of the LPAR is in the CPU group # (303) of the CPU management table 300 (S601). When there is the same group #, then a memory block size is obtained, at which the MC # (407) of the memory management table 400 is the same as the MC # (304) of the CPU management table 300 having the group # and the LPAR # (402) of the memory management table 400 is 0 (S602). When the memory block size is below the logical memory size (203) of the LPAR (S603), it is determined that the memory blocks cannot be allocated, resulting in an LPAR activation error (S607).

When the memory block size is equal to or larger than the logical memory size (203) of the LPAR (S603), the memory blocks are allocated to the LPARs and thus the CPU management table 300 and the memory management table 400 are changed to a state of being allocated to the LPAR. First, the LPAR # is added to the LPAR # using the CPU (302) corresponding to the physical CPU determined to be allocatable to the LPAR (S604). Finally, the LPAR # (402) of the unused memory blocks in the memory management table 400 is set to the LPAR # (S605).

When the LPAR group # (204) of the LPAR is 0 as a result of checking if the value of the LPAR group # of the LPAR is 0 (S600), it is checked if the number of unused physical CPUs in the same memory controller is equal to or larger than the number of logical CPUs (202) of the LPAR. In order to check this, the number of CPUs having the same MC # (304) and the LPAR # using the CPU (302) of 0 in the CPU management table 300 is compared with the number of logical CPUs (202) of the LPAR (S606).

When the number of unused CPUs is equal to or larger than the number of logical CPUs (202) of the LPAR, then a memory block size is obtained, at which the MC # (407) of the memory management table 400 is the same as the MC # (304) of the CPU management table 300 having the group # and the LPAR # (402) of the memory management table 400 is 0 (S602). When the memory block size is below the logical memory size (203) of the LPAR (S603), it is determined that the memory blocks cannot be allocated, resulting in the LPAR activation error (S607).

When the memory block size is equal to or larger than the logical memory size (203) of the LPAR (S603), the memory blocks are allocated to the LPARs and thus the CPU management table 300 and the memory management table 400 are changed to a state of being allocated to the LPAR. First, the LPAR # is added to the LPAR # using the CPU (302) corresponding to the physical CPU determined to be allocatable to the LPAR (S604). Finally, the LPAR # (402) of the unused memory blocks in the memory management table 400 is set to the LPAR # (S605).

Accordingly, the physical CPUs and the physical memories to be allocated to the LPARs coincide with the MC # (304) in the CPU management table 300 and the MC # (407) in the memory management table 400. Moreover, as the allocated physical CPUs and physical memories, those not in both CPU modules but in the same CPU module are used. As a result, according to this embodiment, the physical CPUs and physical memories having a short wiring distance from the memory controller are allocated. Thus, an increase in a wiring distance between the physical CPU and the physical memory, as in allocation between the CPU modules, does not occur, thereby taking into consideration the memory latency.

When the number of unused physical CPUs is below the number of logical CPUs (202) of the LPAR as a result of comparing the number of CPUs having the same MC # (304) and the LPAR # using the CPU (302) of 0 in the CPU management table 300 with the number of logical CPUs (202) of the LPAR (S606), the physical CPUs cannot be allocated, resulting in the LPAR activation error (S607).

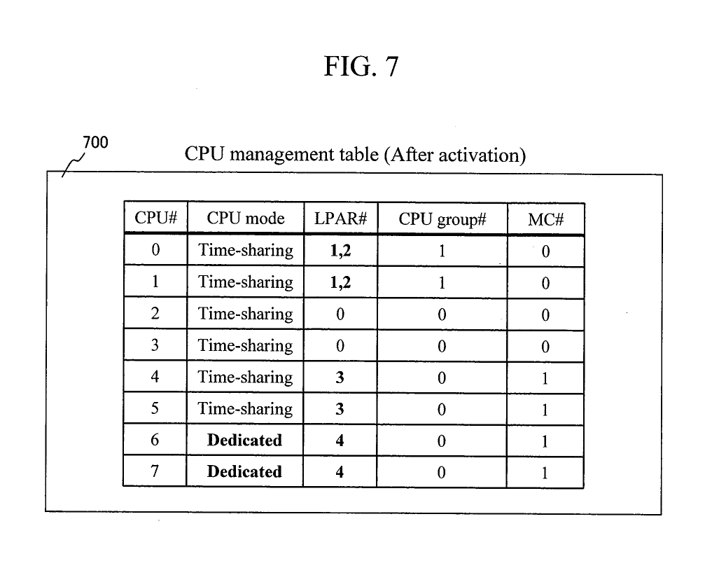

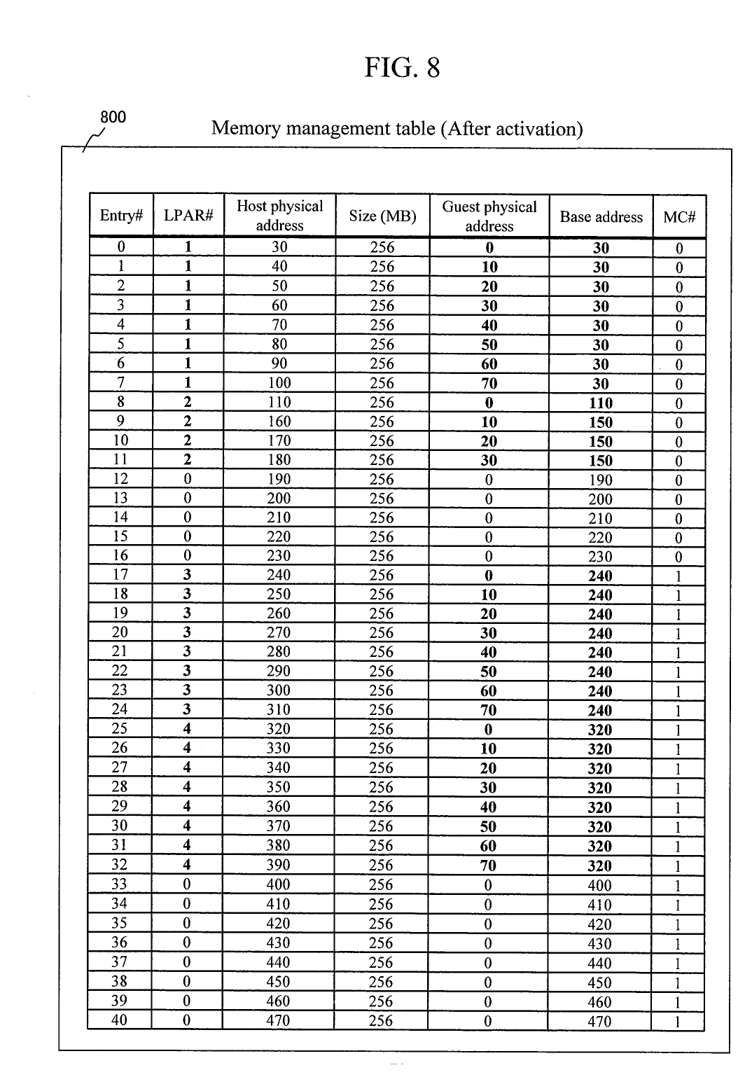

FIG. 7 shows an example of a CPU management table 700 after activation of the four LPARs 103 to 106 shown in FIG. 1. Moreover, FIG. 8 shows an example of a memory management table 800 after activation of the four LPARs 103 to 106 shown in FIG. 1. Consecutive guest physical addresses from 0 are allocated to one LPAR, and an address obtained by adding a base address to the guest physical address serves as a host physical address. It is obvious that the physical CPU and physical memory allocated to one LPAR have the same MC #.

The present invention enables allocation of physical CPUs of each LPAR in a virtual computer system in consideration of memory latency. Moreover, the present invention can be applied to an operation of constructing a virtual computer system not conscious of performance degradation due to the memory latency in construction of the virtual computer system whose performance is demanded.

### EXPLANATION OF REFERENCE NUMERALS

100 server module
101 hypervisor
102 LPAR group
103-106 LPAR
107, 108 CPU module
109 CPU group
110-117 physical CPU
118, 119 memory controller
120-125 DIMM
126, 127 hypervisor memory area
128 memory area of LPAR1
129, 130 memory area of LPAR2
131 memory area of LPAR3
132 memory area of LPAR4

What is claimed is:

1. A virtual server system comprising:
a plurality of CPU modules each including a plurality of physical CPUs and a memory controller;
a plurality of physical memories connected to the memory controller of each CPU module;
a hypervisor allocating the physical CPUs and physical memory blocks to a plurality of logical servers;
a logical server configuration management table in which each of the logical servers, a logical CPU mode thereof, a required number of logical CPUs and a required logical memory size are registered in association with each other,
a CPU management table in which information on each of the physical CPUs, a CPU mode thereof, a logical server using the physical CPU, and the memory controller connected to the physical CPU is stored in association with each other, and
a memory management table in which information on a logical server using each of the physical memories and a memory controller connected to the physical memory is stored in association with each other on a unit capacity basis,
wherein, when one of the logical servers is activated, the hypervisor acquires information on the logical CPU mode, the number of logical CPUs and the logical memory size by referring to the logical server configuration management table, allocates to the logical server a required number of physical CPUs from one of the CPU modules by referring to the CPU management table and the memory management table, and then allocates to the logical server a memory block of a required size from the physical memories connected to the memory controller of the allocated physical CPUs.

2. The virtual server system according to claim 1, wherein the logical server configuration management table includes grouping information on the logical servers, and the hypervisor allocates the same physical CPU to a plurality of logical servers belonging to the same group.

3. The virtual server system according to claim 2, wherein, when one of the plurality of grouped logical servers is deactivated and then activated again, the hypervisor allocates the same physical CPU as the previous one to the logical server.

4. An allocation method for allocating a physical CPU and a physical memory block to each logical server by a hypervisor in a server system including: a plurality of CPU modules each including a plurality of physical CPUs and a memory controller; a plurality of physical memories connected to the memory controller of each CPU module; and a logical server configuration management table in which each of the logical servers, a logical CPU mode thereof, a required number of logical CPUs and a required logical memory size are registered in association with each other,
wherein the hypervisor executes the steps of:
initializing a CPU management table and a memory management table, the CPU management table including information on each of the physical CPUs, a CPU mode thereof, a logical server using the physical CPU, and the memory controller connected to the physical CPU associated with each other, and the memory management table including information on a logical server using each of the physical memories and a memory controller connected to the physical memory associated with each other on a unit capacity basis,
acquiring information on the logical CPU and the logical memory size required for an activated one of the logical servers, from the logical server configuration management table;
finding a way for allocating to the logical server a required number of CPUs from the physical CPUs mounted on one of the CPU modules by referring to the CPU management table and the memory management table, and then allocating to the logical server a memory block of a required size from the physical memories connected to the memory controller of the allocated physical CPUs; and
updating the CPU management table and the memory management table when the way is successfully found.

5. The allocation method according to claim 4, wherein, when the logical server configuration management table includes grouping information on the logical servers, the hypervisor allocates the same physical CPU to a plurality of logical servers belonging to the same group.

6. The allocation method according to claim 5, wherein, when one of the plurality of grouped logical servers is deactivated and then activated again, the hypervisor allocates the same physical CPU as the previous one to the logical server.
